(19) United States
(12) Patent Application Publication
(10) Pub. No.: US 2006/0074497 A1
(43) Pub. Date: Apr. 6, 2006

(54) Methods, systems, and articles of manufacture for providing a timing apparatus with an almanac memory

(76) Inventor: Robert E. Pollin, Rockville, MD (US)

Correspondence Address: Mr. Robert E. Pollin, President;AutoScribe Corporation, Suite 200, 9801 Washingtonian Boulevard, Gaithersburg, MD, 20878, US

(21) Appl. No.: 10/952,370

(22) Filed: Sep. 29, 2004

(51) Int. Cl. G05B 11/01

(52) U.S. Cl. 700/14; 700/22; 700/296

(57) ABSTRACT

Methods, systems and articles of manufacture consistent with certain principles related to the present invention allow a timing unit to control power to one or more electrical circuits based on the geographic location of the timing unit and/or the one or more electrical circuits. The timing unit may receive a code form a user, or other source. The timing unit may determine the geographic location of the timing unit or electrical circuits based on the code, and obtain almanac information associated with the determined geographic location. In an embodiment, the almanac information includes estimated times for a sunrise and sunset at the geographic location. The timing unit may then determine whether a current date and time of day related to such sunrise and sunset times is a trigger time, and control power to electrical circuits accordingly.

### FIELD OF THE INVENTION

This invention relates to timing devices for electrical circuits, and more particularly, to methods, systems, and articles of manufacture for providing a user friendly timing device with an almanac memory for controlling electrical circuits.

### BACKGROUND OF THE INVENTION

The automatic control of electrical devices, such as residential lighting fixtures, has been used for a variety of applications. For instance, automatic control systems have been used to control the illumination of areas in or around residences. Some rely on these systems to illuminate areas when inhabitants are absent for extended periods of time. The premise behind such an application is to provide automatic lighting in selected areas of a residence, thus presenting the guise that somebody is present within the residence during the periods of actual inoccupation.

In such applications, a person may program a timer to turn on and off certain electrical devices attached to the timer in pre-selected patterns. The programming however, is generally limited to certain time ranges (i.e., hour based increments), and require the person to adjust the timer to compensate for changes in seasonal characteristics, such as daylight savings time and natural variations in sunrise and sunset times based on geographic locations (i.e., time zones).

To address the limitations of conventional automatic control systems, the use of photocells to detect changes in ambient light have been implemented within these control systems. Photocells may allow a control system to automatically detect changes in light levels and control power to an electrical device based on the detected light levels. For example, a control system that includes a photocell circuit may turn on an electrical device at when diminished sunlight is detected at dusk.

Although a control system that implements photocell technology may provide a less obtrusive technique of controlling electrical devices, such a system is limited in the ability to provide versatility in its control options. That is, because the photocell control device may only power an electrical device based on ambient light levels, a user may not have the option to control how long a particular device is to be powered. Furthermore, such a control system may be affected by non-natural changes in ambient light, such as headlights from a passing vehicle that illuminate on the photocell. Additionally, although programmable photocell control systems have been contemplated, these systems lack the versatility to adjust to seasonal and geographic location adjustments that may affect their performance.

### SUMMARY OF THE INVENTION

It is therefore desirable to have a method and system that allows an electrical circuit to be controlled by a timing unit that autonomously determines when to power on and off the electrical circuit based on a set or determined geographical location of the timing unit and/or the electrical circuit.

Methods, systems and articles of manufacture consistent with certain principles related to the present invention enable the timing unit to perform the above described features by providing access to a memory that maintains almanac or similar information associated with a plurality of geographical locations. In one configuration consistent with certain principles related to the present invention, the timing unit may be configured to receive a code that reflects the current geographical location of the timing unit, and determine estimated times for at least a sunrise and a sunset associated with the current geographical location. The code may be provided by a user, and may reflect one of a zip code, telephone area code, grid coordinates, and time regions. The timing unit may be configured to determine when the date and current time of day matches at least one of the estimated times or a time calculated from one of those estimates, and adjust the power to the electrical circuit based on that determination.

In one configuration consistent with certain principles related to the present invention, a main timing unit may provide information to a plurality of timing units, each timing unit being connected to an electrical circuit. The main timing unit may access almanac information stored in a memory to determine estimated times for a sunrise and sunset at the current geographical locations of at least one of the main timing unit and one or more of the plurality of timing units. When the current time of day matches one of the estimated times, or a time calculated from one of the estimated times, information may be provided to the plurality of timing units to allow them to control the power of its respective electrical circuit.

Additional aspects of the invention will be set forth in part in the description which follows, and in part will be obvious from the description, or may be learned by practice of methods, systems, and articles of manufacture consistent with features of the present invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings,

FIG. 1 illustrates an exemplary timing unit, consistent with certain principles related to the present invention;

FIG. 2 illustrates an exemplary system environment, consistent with certain principles related to the present invention; and

FIG. 3 illustrates a flowchart of an exemplary process performed by a timing unit, consistent with certain principles related to the present invention.

### DETAILED DESCRIPTION

Methods, systems, and articles of manufacture consistent with features and principles of the present invention enable a timing unit to automatically determine a time of day based on the geographical location associated with the timing unit, and control power to an electrical device at a time calculated based on that determination.

Methods, systems and articles of manufacture consistent with certain principles related to the present invention may perform the above functions by allowing the timing unit to receive a code reflecting a current geographical location of the timing unit. The code may reflect a zip code, telephone area code, grid coordinates, and/or time zone information. Furthermore, the timing unit may access a memory including almanac information associated with seasonal characteristics for different geographical locations, including approximate sunrise and sunset times for each location. Additionally, the timing unit may be configured to receive the code from a user through an input/output interface. Once the user supplies the code, the timing unit may automatically control an attached electrical device (or devices) based on the geographical location of the timing unit and/or the electrical device(s). Alternatively, the code may be provided by entities other than a user, such as a Global Positioning System (GPS) module.

In one configuration consistent with certain principles related to the present invention, a main timing unit may be connected to one or more remote timing units. This connection may be obtained through a private or public data network, such as the Internet, cellular networks, short-range wireless networks such as Bluetooth® and the like, packet radio data networks, telephone connections, wireless connections, or any other known method of communications. The main timing unit may be configured to determine the geographic location of the main or remote timing units based on a received code. Furthermore, the main timing unit may also be configured to determine seasonal characteristics associated with the determined geographic location. The main timing unit may provide information to the remote timing units, which may be attached to one or more electrical devices. The remote timing units may control the power to the attached electrical devices based on the information sent by the main timing unit.

In one configuration consistent with certain principles related to the present invention, the geographic and seasonal characteristic information may be located in an almanac memory. The almanac memory may be located within a timing unit, a main timing unit, or may be remotely located from these units. A timing unit may access the almanac memory to determine the seasonal characteristic (i.e., estimated sunrise and/or sunset times) for the geographic location of the timing unit. The geographical and/or seasonal information may also be stored in a remote storage accessible to the timing unit via a network.

Reference will now be made in detail to the exemplary aspects of the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

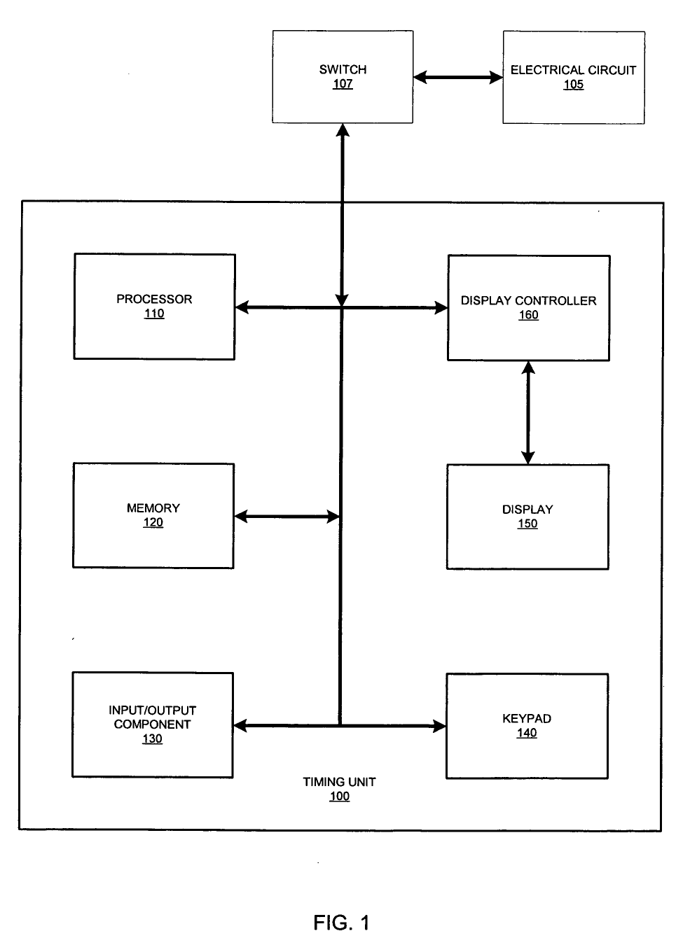

FIG. 1 illustrates an exemplary timing unit 100 consistent with certain principles related to the present invention. Timing unit 100 may be a system that controls the power to one or more electrical circuits 105. In one configuration consistent with certain principles related to the present invention, electrical circuit 105 may include one or more household electrical devices, such as lighting fixtures (i.e., indoor lamps, outdoor porch lights, the light bulbs used in these lighting fixtures, etc.), appliances (i.e., clocks, microwaves, televisions, coffee makers, etc.), any other type of electrical device that receives power that may be controlled. Furthermore, electrical circuit 105 may include the path or paths that provides power to an electrical component, such as an electrical device. Additionally, electrical circuit 105 may include one or more non-household electrical devices such as street lights and the light bulbs included in the street lights. Also, electrical circuit 105 may include one or more devices associated with automobiles, such as the head lamps for an automobile. One skilled in the art would recognize that electrical circuit 105 may include any type of electrical device, component, circuit, and module that has power provided by a power source.

In one configuration consistent with certain principles related to the present invention, timing unit 100 may control power to electrical circuit 105 through a switch 107. Switch 107 may be a system of circuit that controls power to electrical circuit 105 based on information (i.e., data, control signals, etc.) received from timing unit 100. Switch 107 may be controlled using analog signals and/or digital data, both provided by timing unit 100. Switch 107 may block or provide power to electrical circuit 105 provided by a power source (not shown) based on the information provided by timing unit 100. In one configuration consistent with certain principles related to the present invention, switch 107 may include a controller (not shown) that accepts digital data that directs the controller to either block or provide power to electrical circuit 105. One skilled in the art would recognize, however, that timing unit 100 may control power to electrical circuit 105 without switch 107. In this configuration, timing unit may include the necessary components to block and provide power to electrical circuit 105 from a power source.

Timing unit 100 may attach to electrical circuit 105 either directly or indirectly. For example, in one configuration consistent with certain principles related to the present invention, timing unit 100 may replace and/or supplement a household wall mounted light switch for a lighting fixture within a residence. Alternatively, timing unit 100 may be a portable system that may be connected to electrical circuit 105 through various paths and/or intervening components. Also, timing unit 100 may be mounted within an automobile and directly or indirectly connected to electrical circuit 105. Moreover, timing unit 100 may include a local power source (i.e., battery source) or may be connected to a remote power source, such as the power source that provides power to electrical circuit 105.

In one configuration consistent with certain principles related to the present invention, timing unit 100 may comprise processor 110, memory 120, input/output component 130, keypad 140, display 150, and display controller 160. Other components may be associated with timing unit 100 and methods, systems, and articles of manufacture consistent with certain principles related to the present invention are not limited to the exemplary systems described above and illustrated in FIG. 1.

Processor 110 may be a central processing unit that executes instructions and processes associated with methods consistent with certain principles related to the present invention. Furthermore, although FIG. 1 shows a single processor, one skilled in the art would realize that any number of processor architectures may be employed by methods, systems, and articles of manufacture consistent with certain principles related to the present invention without departing from its scope. For example, processor 110 may be a plurality of processors operating in parallel to perform multi-tasking operations. Alternatively, processor 110 may be a controller dedicated to performing specific functions consistent with certain features related to the present invention.

Memory 120 may be any type of storage device that may store data and instructions that are used by processor 110 and any other processing component associated with timing unit 100. Furthermore, memory 120 may also store information that may be used by other components of timing unit 100 certain principles related to the present invention. Memory 120 may be any type of semiconductor, magnetic, optical, and tape storage device and although FIG. 1 shows a single memory, one skilled in the art would realize that any number of different memory architectures may be implemented by methods, systems, and articles of manufacture consistent with certain principles related to the present invention. For example, memory 120 may include one or more storage devices. Also, memory 120 may be supplemented with other storage devices for quick access to information, such as a cache type memory device.

Input/output component 130 may be hardware, software, or any combination thereof, that allows information to be exchanged between timing unit 100 and one or more remote entities. For example, input/output component 130 may include a port that allows outside components to be connected to timing unit 100 to exchange information such as data, instructions, address, and control signals. Additionally, input/output component 130 may allow analog and digital signals to be exchanged with timing unit 100. In one configuration consistent with certain principles related to present invention, analog signals may be exchanged with timing unit 100 through input/output component 130. In this configuration, input/output component 130 may include Analog-to-Digital (A/D) Digital-to-Analog (D/A) converter components that allow timing unit 100 to perform functions consistent with certain principles related to the present invention. One skilled in the art would realize, however, that a variety of different types of components may communicate with timing unit 100 without departing from the scope of the present invention. Furthermore, input/output component 130 may include one or more components that allow information to be exchanged with timing unit 100. In one configuration consistent with certain principles related to the present invention, input/output component 130 may be connected to switch 107 to perform functions consistent with certain principles related to the present invention.

Keypad 140 may be any type of input device that allows a user to enter information in timing unit 100 to be processed by processor 110. For example, keypad 140 may be a keyboard, keypad, touchscreen, a button menu, or any other form of input device that enables timing unit 100 to receive data form a user.

Display 150 may be any type of display device that allows timing unit 100 to present information consistent with certain principles related to the present invention. Display 150 may include a flat screen display device, touchscreen, Liquid Crystal Display (LCD) device, and any other form of known display device that may present visual information.

Display controller 160 may be a component that controls display 150 based on information received from processor 110, keypad 140, input/output component 130, and any other components that may be included in timing unit 100. Display controller 160 may be hardware, software, and any combination thereof, configured to perform functions related to certain principles related to the present invention. Although FIG. 1 shows display controller 160, one skilled in the art would realize that timing unit 100 may be configured in various forms such that display 150 may be controlled by other components, such as processor 110.

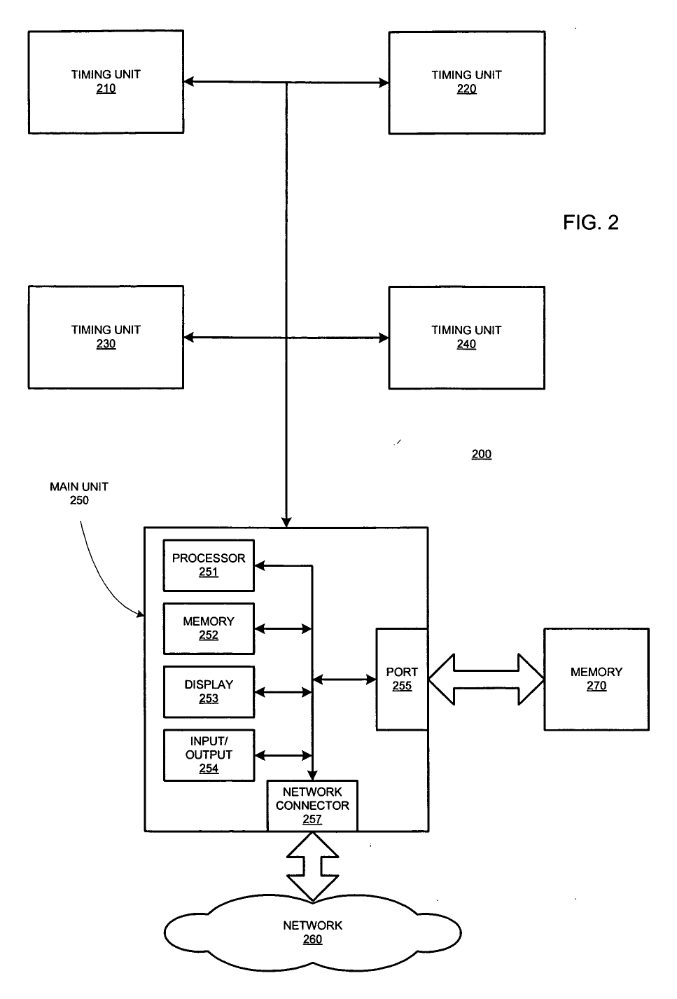

As described, timing unit 100 may include components that allow it to control power to one or more electrical circuits, such as electrical circuit 105. In one configuration consistent with certain principles related to the present invention, a plurality of timing units may be associated with one or more different electrical circuits to provide a network of timing units that may be used to control power to distributed electrical circuits. FIG. 2 shows an exemplary system environment 200 consistent with certain principles related to this configuration.

As shown, system environment 200 may include timing units 210-240, main unit 250, network 260, and memories 270 and 280. Timing units 210-240 may be configured as timing unit 100 described above with respect to FIG. 1. Main unit 250 may be a timing unit that includes components that perform functions similar to those respective components included in timing unit 100. In one configuration consistent with certain principles related to the present invention, main unit 250 may include additional components that perform functions consistent with certain principles related to the present invention. Main unit 250 may also be a computer system, such as a personal computer, workstation, laptop, or any other similar computer system known in the art. For instance, main unit 250 may comprise processor 251, memory 252, display 253, and input/output 254, memory port 255, and network connector 257. Processor 251 may be any known processor that executes instructions and processes known in the art. Additionally, processor 251 may perform functions consistent with certain principles related to the present invention. Processor 251 may be a single processor or a plurality of processors operating in parallel to perform multi-tasking operations. One skilled in the art would realize that any number of types of processors and processing architectures may be implemented in main unit 250 without departing from the scope of the invention.

Memory 252, may be any known storage device that stores data and instructions to be used and executed by processor 251, and any other component included in main unit 250. Memory 252 may also store information consistent with certain principles related to the present invention, such as that described for memory 120. Display 253 may be any known display device that presents information to a user. For example, display 253 may include a known computer system display device, touchscreen, LCD, and any other type of display device that is known in the art. Input/output component 254 may be hardware, software, or any combination thereof, that allows information to be exchanged between main unit 250 and any remote entities connected to main unit 250. Memory port 255 may be any hardware, software, or combination thereof, device that allows information to be exchanged between main unit 250 and memory 270. Although FIG. 2 only shows only one port 255, one skilled in the art would realize that additional ports may be implemented with main unit 250 to exchange information between main unit 250 and any other type of storage devices. Network connector 257 may hardware, software, or any combination thereof, that allows information to be exchanged with network 260.

Memory 270 may be any type of storage device that stores data used by main unit 250 consistent with certain principles related to the present invention. For example, memory 270 may include magnetic, optical, tape, and semiconductor type storage devices. Furthermore, memory 270 may represent portable storage devices that may be inserted into memory port 255, such as a floppy diskette or compact disk.

Network 260 may include one or more communication networks, including the Internet, packet radio networks, private data networks, low power cellular networks, cellular data networks, the public switched telephone network, cable data networks, satellite data networks, or any other network capable of interconnecting main unit 250 with remote entities connected to network 260.

It should be noted that he configuration of system environment 200 is exemplary and not intended to be limiting. One skilled in the art would realize that any number of configurations may be implemented by methods, systems, and articles of manufacture consistent with certain principles related to the present invention without departing from its scope. For example, main unit 250 may include additional components (not shown) consistent with computer systems known in the art, such as a keyboard, mouse, cache memories, etc.

Methods, systems, and articles of manufacture consistent with certain principles related to the present invention allow timing unit 100 to be associated with one or more electrical circuits 105 to control power thereto. As previously mentioned, electrical circuit 105 may represent any number of different types of electrical circuits and/or devices, and are not limited to the examples described above. For exemplary purposes only, features consistent with certain principles related to the present invention that may be provided by timing unit 100 will be described in association with an electrical circuit representing a lighting fixture included in a residence. One skilled in the art would realize that this example is not intended to be limiting, and that the following exemplary features described may apply to any type of electrical circuit that may have its power supplied by a power source.

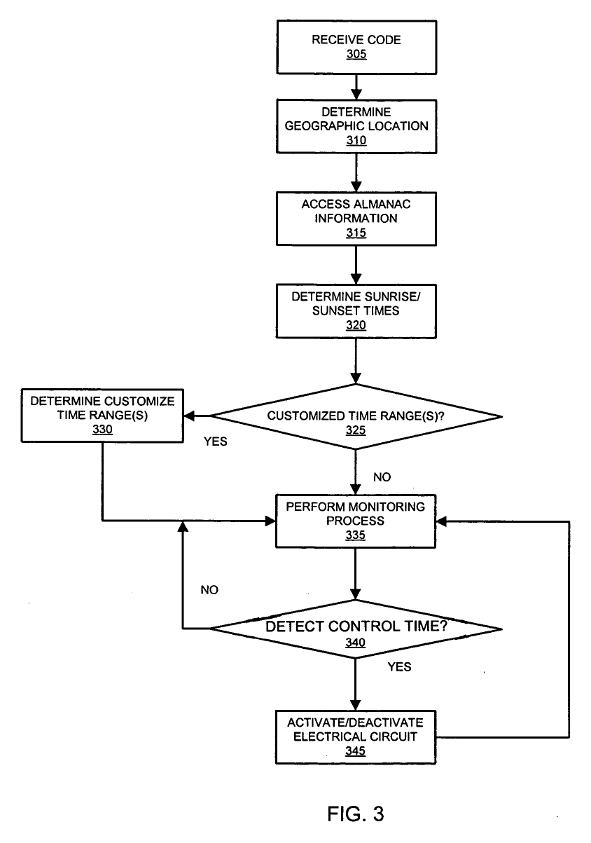

FIG. 3 shows a flowchart of an exemplary process that may be performed by timing unit 100 consistent with certain principles related to the present invention. Once timing unit 100 has been associated with electrical circuit 105, indirectly through switch 107, or directly, a user may program it to perform functions consistent with certain principles related to the present invention. In one configuration consistent with certain principles related to the present invention, timing unit 100 may receive a code that reflects a geographic location of timing unit 100 (Step 305). The code may be a zip code, telephone area code, time zone information, geographic grid coordinates, and/or any other information associated with the geographic location of timing unit 100. The code may supplied by a user in response to a query presented on display 150, or may be provided by the user without such a query. Display 150 may provide the query in a manner that allows the user to present the code. Furthermore, display 150 may provide a menu that includes the zip codes, telephone area codes, time zone information, and other geographic location information that a user may select. In one configuration consistent with certain principles related to the present invention, the code may be provided automatically be a Global Positioning System (GPS) that may be included within timing unit 100, or connected remotely. The GPS may provide geographic location information automatically to timing unit 100 based on the position of the timing unit. Furthermore, the code, regardless of its source, may be stored in memory 120 for use by processor 110. Alternatively, the code may be stored in an memory internal to processor 110, such as a register and/or a RAM storage device, or a remote memory accessible by processor 110.

Once the code is received by timing unit 100, processor 110 may determine the geographic location of timing unit 100 based on the received code (Step 310). In one configuration consistent with certain principles related to the present invention, memory 120 may maintain almanac information associated with a plurality of geographic locations. For example, memory 120 may include a list, table, array, file, and any other arrangement of information, that correlates codes with geographic locations. For instance, memory 120 may include a table of zip codes and their corresponding geographic locations. Alternatively, memory 120 may include a listing of time zones or telephone area codes correlated with their geographic regions. Memory 120 may also contain data that determines an approximate geographic location based on data that is provided by the user, such as the current time of sunrise or sunset at that location. An approximate geographic location within a region, such as the continental United States, could be approximated for a given date based on such information. This approximating feature may operate within a defined region, such as the continental United States, or data that provides an indication of latitude may be input by the user. For example, the user may select a country, state, or may select from predetermined latitude bands dividing the earth into ranges where sunrise and sunset would occur within a defined period. In an embodiment, these bands may be labeled “northern hemisphere near the equator,” “middle northern hemisphere,” “north polar,” etc. Furthermore, memory 120 may include a file of geographic grid coordinates and their correlated geographic locations. One skilled in the art would realize that memory 120 may include a variety of types of geographic location information and corresponding codes without departing from the scope of the invention. Accordingly, processor 110 may analyze the received code with the geographic location information maintained in memory 120 to determine the approximate geographic location of timing unit 100, based on the received code.

In one configuration consistent with certain principles related to the present invention, processor 110 may automatically update current almanac information associated with timing unit 100 that may be stored in memory 120 (Step 320). This may be performed by processor 110 determining whether the current geographic location determined in Step 310 is different from a geographic location previously determined by processor 110. For example, timing unit 100 may initially have been operated in Albany, N.Y., and subsequently moved and operated in San Francisco, Calif. Processor 110 may be configured to detect a new current geographic location based on the received code, which, for example, may be zip codes, telephone area codes, grid coordinates, and time zone information associated with the exemplary geographic locations.

Once the geographic location of timing unit 100 has been determined based on the received code, processor 110 may access almanac information to determine specific characteristics associated with the determined geographic location of timing unit 100 (Step 315). In one configuration consistent with certain principles related to the present invention, the almanac information may be stored in memory 120. Alternatively, the almanac information may be stored in a memory remotely located from timing unit 100 and accessed by processor 110 through a communications link, such as input/output component 130.

The almanac information may include information reflecting characteristics associated with geographic locations. For example, the almanac information may include estimated times associated with on and off triggers, such as a sunset and/or sunrise at particular geographic locations. For example, a geographic location in the east coast of the United States may have an estimated sunrise time that differs from a geographic location in the west coast of the United States. Also, the almanac information may include daylight savings time information associated with particular geographic locations (i.e., dates and time of day data). The almanac information may also include seasonal and environmental information known to be included in hard copy almanacs. One skilled in the art would realize that the examples listed above are exemplary and not intended to be limiting. The almanac information may include many different types of information (i.e., data associated with on and off triggers) from which timing unit may use to control power to electrical circuit 105, without departing from the scope of the present invention. For exemplary purposes only, the description of the process depicted in FIG. 3 will be associated with almanac information reflecting estimated sunrise and sunset times of various geographic locations.

Once the almanac information is accessed, processor 110 may then determine the appropriate characteristic data that may be used to control electrical circuit 105. For example, processor 110 may use the determined geographic location to collect estimated time data associated with a sunrise and sunset for the determined geographic location based on current date and time of day data (Step 320). The current date and time of day data may be maintained by an internal non-volatile clock (not shown) within timing unit 100. Alternatively, the current date and time data may be maintained by a remote master clock, such as an external atomic based clock system that ensures accurate date and time of day information. In this configuration, timing unit 100 may be configured to synchronize its internal clock with the remote master clock periodically, or based on a request initiated by processor 110, a user, and a specified event that may be programmed into processor 110. Those skilled in the art will appreciate that different techniques to maintain a synchronized and accurate clock may be employed by methods, systems, and articles of manufacture consistent with certain principles related to the present invention without departing from its scope.

The determined estimated sunrise and sunset times may be stored in memory 120 for subsequent use by processor 110. Alternatively, processor 110 may access a network, such as the Internet, to obtain the sunrise and sunset times from a remote source. Processor 110 may then determine whether timing unit 100 has been programmed for one or more customized time ranges associated with the control of power to electrical circuit 105 (Step 325). A customized time range may be associated with a predetermined on/off pattern, a length of time that power may be provided or shut off to electrical circuit 105, and/or a time calculated from a sunrise or sunset time. For example, a user may program timing unit 100 to provide power (or shut off power) to electrical circuit 105 for a specified length of time. A user may specify that timing unit 100 provide power to electrical circuit 105 for 2 hours once power is initially provided to electrical circuit 105. Also, a user may specify that timing unit 100 maintain a power off condition for electrical circuit 105 for 2 hours once power has been initially shut down by timing unit 100. Furthermore, a user may specify a pattern of shutting down and providing power to electrical circuit 100 that is to begin once power has been initially provided or shut down to electrical circuit 105. Those skilled in the art will recognize that that the above examples are not intended to be limiting, and different patterns, time ranges, etc., may be employed by timing unit 100 without departing from the scope of the present invention.

Accordingly, if a customized time range has been programmed into timing unit 100, processor 110 may determine the time range (Step 330), and then perform a monitoring process (Step 335). In the event, however, that a customized time range has not been programmed, or not employed by, timing unit 100 (Step 325; NO), processor 110 may proceed directly to perform the monitoring process (Step 335). The monitoring process enables processor 110 to determine whether an event occurred that triggers processor 110 to control power (on or off) to electrical circuit 105. In one configuration consistent with certain principles related to the present invention, processor 110 may analyze the current date and time associated with timing unit 100 with the estimated sunrise and/or sunset times stored in memory 120. In step 340, processor 110 determines whether the current date and time of day matches a control time. A control time may be (for example) a fixed time, a sunrise and/or sunset estimated time, or a time calculated from a sunrise or sunset estimated time. A control time may also be a time established by a customized time range to provide a desired on/off pattern. In response to detection of a control time, power may be controlled to electrical circuit 105 (Step 345). For example, suppose an estimated sunset and sunrise time for the current date and geographic location of timing unit 100 is 6:00 AM and 8:45 PM, respectively. Processor 110 may analyze the internal clock of timing unit 100 to determine when it matches one of the estimated times. Accordingly, when the internal clock of timing unit 100 reaches 8:30 PM, 15 minutes before sunset time, processor 110 may be configured to send instructions, control signals, or the like, to switch 107 to provide power to electrical circuit 105. Also, processor 110 may also be configured to detect when the internal clock reaches 6:00 AM, and provide instructions, control signals, or the like, to switch 107 to shut off power to electrical circuit 105.

Step 330, the determination of the time range, may include performing calculations relative to a customized time such as sunrise or sunset. In particular, the user may be provided with the option of actuating or de-actuating electrical devices at a time related to, but not identical to, a time such as sunrise or sunset. For example, the user may wish to activate pathway lights at some designated offset time related to a predicted sunset time (either before or after sunset), and turn them off either at a designated time later that evening or at a designated time related to the approximate time of sunrise (either before or after sunrise). Table A provides several examples of such designations. Of course, the options for operating the system are not limited to these examples. In a preferred embodiment, any desired combination of customized times based on almanac information, positive or negative offsets relative to those times, and predetermined fixed times may be used as times for actuating or de-actuating controlled devices. Time data specifying the activation and de-activation of devices connected to timing unit 100 is stored in timing unit 100 and can be used by processor 110 in step 330 to calculate whether any devices are to be actuated or de-actuated at the present time.

TABLE A

| ACTIVATE | DE-ACTIVATE |
|---|---|
| SUNSET − 30 | 11:30 p.m. |
| (30 minutes before sunset) | |
| SUNSET + 60 | 2 a.m. |
| (one hour after sunset) | |
| SUNSET + 45 | SUNRISE + 15 |
| (45 minutes after sunset) | (15 minutes after sunrise) |
| 8 p.m. | SUNRISE − 120 |
| | (two hours before sunrise) |

As described, timing unit 100 may be associated with one or more electrical circuits 105 to control power thereto based on selected criteria, such as almanac information (i.e. sunrise, sunset data, etc.). In one configuration consistent with certain principles related to the present invention, the features of timing unit 100 may be employed in system environment 200 to control power to a plurality of distributed electrical circuits 210-240. In this configuration, main unit 250 may be configured to receive almanac information from a variety of sources, including entities connected to network 260 (i.e., servers, workstations, remote memories, etc.). Furthermore, main unit 250 may receive almanac information from memory 270, which may or may not be downloaded to memory 252 for storage.

Main unit 250 may also be configured to receive the geographic location code in a manner similar to the code received by timing unit 100 described above. That is, main unit 250 may automatically receive the code from a GPS circuit, or from a user. Also, main unit 250 may determine characteristic information (i.e., estimated sunrise and/or sunset times) associated with timing units 210-240 or with main unit 250 based on the almanac information in a manner similar to that described for timing unit 100. Main unit 250 may also perform a monitoring process to determine whether an event occurs that would trigger a power control situation for selected timing units 210-240 associated with their respective electrical circuits. For example, main unit 250 may determine when a current date and time of day associated with main unit 250 matches an estimated sunset time. If such a match occurs, main unit 250 may be configured to send instructions, control signals, or the like to timing units 210-240 to indicate that a power control event has occurred and that power is to be provided to the timing unit's respective electrical circuits. In one configuration consistent with the present invention, the instructions, control signals, or the like, sent by main unit 250 may be received by the timing unit's 210-240 respective processors. These processors may then be invoked to provide respective instructions, control signals, or the like, to the electrical circuit(s) they are associated with, either directly or indirectly (i.e., through a switch device).

In one configuration consistent with certain principles related to the present invention, main unit 250 may be configured to supply at least one of the almanac information, received code, determined geographic location, and/or determined characteristic information (i.e., estimated sunrise and/or sunset times) to timing units 210-240. In this configuration, each timing unit 210-240 may perform a respective monitoring process in a manner similar to that described for timing unit 100 to determine when to provide power to their associated electrical circuits.

Methods, systems, and articles of manufacture consistent with certain principles related to the present invention, may be implemented in system environment 200 to allow electrical circuits that are distributed in remote location to be controlled. Main unit 250 may allow a user to control the distributed electrical circuits from a single location using one or more codes. For example, in one configuration consistent with certain principles related to the present invention, main unit 250 may manage the control of power to the distributed electrical circuits associated with timing units 210-240 based on the geographic location of main unit 250. Alternatively, the management and/or control of the distributed electrical circuits may be based on the geographic locations of one or more of timing units 210-240. In this case, a central location may be used by a user to control power to an electrical device that is located in a geographic location different than that of the other timing units as well as main unit 250. For example, main unit 250 may be located in Richmond, Va., while timing units 210 and 220 are located in Philadelphia, Pa., and timing units 230, 240 are located in Denver, Colo. Accordingly, based on the separate geographic locations and time zones, main unit 250 may provide a customized power control option that enables a user to designated separate geographic locations for separate timing units 210-240 based on separate codes. Alternatively, a GPS system may be associated with each timing unit 210-240 to main unit 250, thus allowing selective power control operations to be managed and controlled from main unit 250. Furthermore, one skilled in the art would realize that the customized time range features described with respect to FIG. 3 may also be employed in system environment 200 by methods, systems, and articles of manufacture consistent with certain principles related to the present invention.

As described, methods, systems, and articles of manufacture consistent with certain principles related to the present invention enable a timing unit to control power to one or more electrical circuits based on the geographic location of the timing unit and/or the electrical circuit. Although the configuration of the systems and methods described above allow the present invention to perform the above noted functions, variations of the methods and systems consistent with features of the present invention previously described may be implemented without departing from the scope of the invention. For example, methods, systems, and articles of manufacture, consistent with certain principles related to the present invention may be implemented using various processing architectures, models, and components, and is not limited to the configurations shown in the figures. Furthermore, methods, systems, and articles of manufacture, consistent with features of the present invention may be implemented by systems and processes compatible with software written in a number of different programming languages without departing from the scope of the present invention.

Additionally, in one configuration consistent with certain principles related to the present invention, a timing unit may obtain codes associated with geographic locations from a network, such as the Internet. For example, a timing unit may be attached to a network and automatically access the network to obtain geographic location information associated with the current location of the timing unit. The timing unit may be configured to obtain location profile data associated with an Internet Protocol (IP) address associated with a connection port the timing unit may use to access the network. The location profile data may include codes associated with the geographic location for the connection port. Alternatively, an area code associated with the telephone number a modem may use to access the network may be obtained by the timing unit. One skilled in the art would realize that the source of the codes used by a timing unit to determine a geographic location may vary, and the techniques employed to obtain the codes from the various sources may also vary without departing from the spirit and scope of the present invention.

Also, application of methods, systems, and articles of manufacture consistent with certain principles related to the present invention are not limited to the particular examples described above. For example, timing unit 100 may be utilized in an automobile to control the power to the vehicle's headlamps. In this configuration, the timing unit may receive a code from a user, or a GPS system, to adjust automatically control the power to the headlamps based on the current geographic location of the automobile. Additionally, timing unit 100 may also be configured to receive information other than almanac information. For example, timing unit 100 may be configured to receive local weather information from a remote source (i.e., web site). A network connected to the source and timing unit 100 may allow weather information associated with the geographic location of timing unit 100 to be received by timing unit 100 periodically. This configuration may be applied to electrical circuits that control power to sprinkler systems for landscapes surrounding residential or commercial structures. Timing unit 100 may be configured to translate the weather information from the source in such a manner that the estimated chance of precipitation for the geographic location of the timing unit may be determined. Based on this determination, timing unit 100 may determine to shut down power to a sprinkler system that is currently providing water to a landscape that may be receiving rain fall. Alternatively, based on a monitored lack of rainfall, timing unit 100 may be configured to provide power to the sprinkler system to provide additional water to the landscape.

One skilled in the art would realize that applications for the timing units described above are not limited to the above examples. The timing units may be incorporated to control power to a variety of different types of electrical circuits that may control a variety of different types of devices, systems, and/or components. Additionally, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described aspects of the invention, but instead is defined by the appended claims in light of their full scope of equivalents.

What is claimed is:

1. A method for controlling an electrical circuit, the method comprising:
determining at least one of an approximate sunrise time and an approximate sunset time at a geographic location, based on a received location indicating code;
obtaining a current date and time; and
changing a state of the electrical circuit at a time calculated based on one of said sunrise time and said sunset time.

2. The method of claim 1, wherein the code is provided by a user.

3. The method of claim 1, wherein the code is one of a zip code, a telephone area code, a time zone, a geographic region code, and grid coordinates.

4. The method of claim 1, wherein said determining step comprises:
accessing a memory including almanac information reflecting estimated times associated with a sunrise for various geographic locations.

5. The method of claim 1, wherein said determining step comprises:
accessing a memory including almanac information reflecting estimated times associated with a sunset for various geographic locations.

6. The method of claim 1, wherein said step of changing a state comprises:
providing power to the electrical circuit when it is determined that the current time matches a time related to said sunset time; and
shutting off power to the electrical circuit when it is determined that the current time matches a time related to said sunrise time.

7. The method of claim 1, wherein the step of changing a state comprises:
providing power to the electrical circuit for a predetermined amount of time when it is determined that the current time matches a time related to the sunset time.

8. The method of claim 1, wherein the step of changing a state comprises:
repeating a pattern of shutting off power and providing power to the electrical circuit for a predetermined amount of time when it is determined that the current time matches a time related to the sunset time.

9. The method of claim 1, wherein said determining step comprises:
retrieving almanac information from a remote location, wherein the almanac information includes an estimated sunrise time.

10. The method of claim 4, further comprising:
automatically updating the memory with new almanac information.

11. The method of claim 5, further comprising:
automatically updating the memory with new almanac information.

12. The method of claim 1, further comprising:
receiving a new code;
determining a new geographic location based on the new code;
determining an approximate new sunrise time for the new geographic location based on the current date;
determining an approximate new sunset time for the new geographic location based on the current date; and
changing a state of a second electrical circuit at a time calculated based on one of said new sunrise time and said new sunset time.

13. A method for controlling an electrical device, comprising:
storing information reflecting a geographic location;
determining an event time based on the stored information; and
controlling power to an electrical device based on the determined event time.

14. The method of claim 13, wherein controlling power to the electrical device further comprises:
providing power to the electrical device based on a determination that the current time matches the event time.

15. The method of claim 13, wherein controlling power to the electrical device further comprises:
shutting down power to the electrical device based on a determination that the current time matches the event time.

16. The method of claim 13, wherein determining a geographic location comprises:
determining the geographic location based on a received code.

17. The method of claim 16, wherein the code is received from one of a user and a GPS system.

18. The method of claim 16, wherein the code is one of a zip code, a telephone area code, a time zone, a geographic region code, and grid coordinates.

19. The method of claim 13, wherein the timing unit includes a memory containing a plurality of estimated times for at least one of a sunset and sunrise associated with a plurality of geographic locations, and wherein determining an event time comprises:
retrieving, from the memory, the event time based on the determined geographic location, wherein the event time is associated with an estimated time of day for one of a sunset or sunrise associated with the determined geographic location.

20. The method of claim 13, wherein the system further comprises a memory containing a plurality of event times for at least one of a sunset and sunrise associated with a plurality of geographic locations, and wherein determining an event time comprises:
retrieving, from the memory, the event time based on the determined geographic location, wherein the event time is associated with an estimated time of day for one of a sunset or sunrise associated with the determined geographic location.

21. The method of claim 20, wherein the timing unit and memory are connected to a network and wherein retrieving, from the memory, the event time comprises:
retrieving, from the memory, the event time through the network.

22. A system for controlling one or more electrical devices, comprising:
a remote timing unit for controlling power to an electrical device; and
a main timing unit, connected to the remote timing unit, for determining a geographic location of at least one of the main and remote timing units, wherein the main timing unit is configured to determine a time of an event based on the geographic location, and to provide information to the remote timing unit for controlling the power to the electrical device based on the determined time.

23. The system of claim 22, wherein the event is a time relative to sunset associated with the geographic location and the information includes instructions for providing power to the electrical device, and wherein the main timing unit is further configured to provide, to the remote timing unit, the instructions based on a determination that the current time matches the time of the event.

24. The system of claim 22, wherein the event is a time relative to sunrise associated with the geographic location and the information includes instructions for shutting down power to the electrical device, and wherein the main timing unit is further configured to provide, to the remote timing unit, the instructions based on a determination that the current time matches the time of the event.

25. The system of claim 22, wherein the geographic location is determined by a code received by the main timing unit.

26. The system of claim 25, wherein the code is provided by one of a user and a GPS system.

27. The system of claim 25, wherein the code is one of a zip code, a telephone area code, a time zone, a geographic region code, and grid coordinates.

28. The system of claim 22, wherein the main timing unit includes a memory containing a plurality of time of events associated with a plurality of geographic locations, and wherein the main timing unit retrieves, from the memory, the time of the event based on the determined geographic location.

29. The system of claim 22, further comprising a memory containing a plurality of time of events associated with a plurality of geographic locations, and wherein the main timing unit retrieves the time of the event from the memory based on the determined geographic location.

30. The system of claim 29, wherein the main timing unit and memory are connected to a network and the main timing unit retrieves the time of the event from the memory through the network.

31. A system for controlling an electrical device, comprising:
an electrical device; and
a timing unit for controlling power to the electrical device, wherein the timing unit is configured to determine a geographic location associated with the timing unit, determine an event time based on the geographic location, and control power to the electrical device based on the determined event time.

32. The system of claim 31, wherein the timing unit is further configured to:
provide power to the electrical device based on a determination that the current time matches the event time.

33. The system of claim 31, wherein timing unit is further configured to:
shut down power to the electrical device based on a determination that the current time matches the event time.

34. The system of claim 31, wherein the geographic location is determined by a code received by the timing unit.

35. The system of claim 34, wherein the code is provided by one of a user and a GPS system.

36. The system of claim 34, wherein the code is one of a zip code, a telephone area code, a time zone, a geographic region code, and grid coordinates.

37. The system of claim 31, wherein the timing unit includes a memory containing a plurality of event times associated with a plurality of geographic locations, and wherein the timing unit retrieves, from the memory, the event time based on the determined geographic location.

38. The system of claim 31, further comprising a memory containing a plurality of event times associated with a plurality of geographic locations, and wherein the timing unit retrieves, from the memory, the event time based on the determined geographic location.

39. The system of claim 38, wherein the timing unit and memory are connected to a network and the timing unit retrieves the event time from the memory through the network.

40. A system for controlling an electrical circuit, comprising:
an electrical circuit; and
a timing unit, comprising:
a processor,
a memory including information reflecting at least one event associated with a plurality of geographic locations,
an input component for receiving a code, and
a display for presenting information,
wherein the processor is configured to access the information in the memory to determine a time associated with at least one event associated with a geographical location of the timing unit, and control power to the electrical circuit based on a determination whether a current time matches the determined time.

41. A method performed by a computer system, comprising:
receiving information reflecting a geographic location;
selecting at least one trigger based on the geographic location; and
controlling power to an electrical circuit based on a determination whether the at least one trigger has been detected.

42. The method of claim 41, wherein the information includes one of a zip code, a telephone area code, a geographic region code, region code, and grid coordinates.

43. The method of claim 41, wherein selecting at least one trigger comprises:
accessing a memory including a plurality of geographic locations each associated with at least one trigger; and
selecting, from the memory, the at least one trigger based on the received information.

44. The method of claim 43, wherein the at least one trigger is an on trigger and wherein controlling an electrical circuit further comprises:
providing power to the electrical circuit based on the determination that a current time matches an event time associated with the on trigger.

45. The method of claim 43, wherein the at least one trigger is an off trigger and wherein controlling an electrical circuit further comprises:
shutting off power to the electrical circuit based on the determination that a current time matches an event time associated with the off trigger.
